(19) United States
(12) Patent Application Publication
(10) Pub. No.: US 2017/0344715 A1
(43) Pub. Date: Nov. 30, 2017

(54) HEALTH MANAGING DEVICE AND HEALTH MANAGING METHOD

(71) Applicant: Hangzhou Mega Inno of Health Technology Co. Ltd, Hangzhou (CN)

(72) Inventor: PING-HAO LIU, New Taipei (TW)

(21) Appl. No.: 15/607,421

(22) Filed: May 26, 2017

(30) Foreign Application Priority Data
May 28, 2016 (CN) 201610370704.7

(51) Int. Cl. G06F 19/00

(52) U.S. Cl. CPC G06F 19/3406; G06F 19/3418; G06F 19/345

(57) ABSTRACT

A health managing device includes a storage, at least one processor, a display screen, a display module, and a detection module. The display module and the detection module are stored in the storage. The display module is configured to provide an operating interface. The operating interface is displayed on the display screen. The operating interface comprises a plurality of function options. The detection module is configured to determine which function option is selected by a user. The detection module is further configured to trigger the function corresponding to the selected function option. A health managing method is also provided.

### FIELD

The subject matter herein generally relates to an electronic device and a managing method for a user to manage the user's health.

### BACKGROUND

Electronic devices, such as a mobile phone, a personal computer, a panel personal computer, or a personal digital assistant, are always used for amusement or for working. Users usually carry their mobile phones. Health is very important for people. An electronic device should be used to manage the health.

### BRIEF DESCRIPTION OF THE DRAWINGS

Implementations of the present technology will now be described, by way of example only, with reference to the attached figures.

FIG. 1 is a block diagram of one embodiment of a health managing device communicating with a doctor terminal and a cloud server.

FIG. 2 is a block diagram of one embodiment of a health managing system of FIG. 1.

FIG. 3 is a block diagram of one embodiment of a display screen of the health managing system of FIG. 1.

FIGS. 4-7 are a flowchart of one embodiment of a health managing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

The present disclosure is described in relation to a device for a user to communicate with a medical terminal (doctor terminal) to help the user manage his own health.

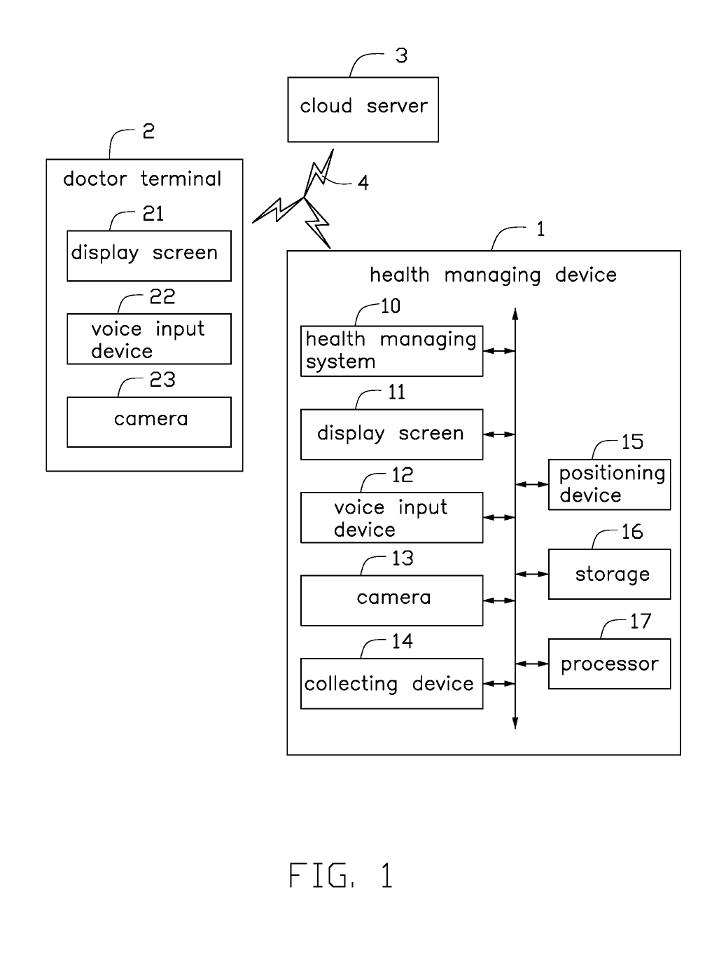

FIG. 1 illustrates an exemplary embodiment of a health managing system 10. In at least one exemplary embodiment, the health managing system 10 is installed in a health managing device 1. The health managing device 1 is in wireless communication with at least one doctor terminal 2 through network 4. The health managing device 1 wirelessly communicates with a cloud server 3 through the network 4. In the exemplary embodiment, one doctor terminal 2 is taken as an example.

In at least one exemplary embodiment, the health managing device 1 can be a multi-parameter monitor, a mobile phone, a personal computer, a panel personal computer, or a personal digital assistant, and the doctor terminal 2 can be a mobile phone, a personal computer, a panel personal computer, or a personal digital assistant. Each of the health managing device 1 and the doctor terminal 2 can comprise a circuit system, a sound system, at least one input/output (I/O) interface, a battery, and an operating system.

The network 4 can be wired network or wireless network, such as Internet, local area network, Wire Fidelity (WI-FI), honeycomb, satellite, or broadcast. The wireless communication can be global system for mobile communications (GSM), general packet radio service (GPRS), code division multiple access (CDMA), W-CDMA, CDMA2000, IMT Single Carrier, enhanced data rates for GSM evolution (EDGE), long-term evolution (LTE), time-division LTE (TD-LTE), high performance radio local area network (HiperLAN), high performance radio wide area network (HiperWAN), local multipoint distribution service (LMDS), worldwide interoperability for microwave access (WiMAX), ZIGBEE, BLUETOOTH, flash orthogonal frequency-division multiplexing (Flash-OFDM), high capacity spatial division multiple access (HC-SDMA), universal mobile telecommunications system (UMTS), UMTS time-division duplexing (UMTS-TDD), evolved high speed packet access (HSPA+), time division synchronous code division multiple access (TD-SCDMA), evolution-data optimized (EV-DO), and digital enhanced cordless telecommunications (DECT).

In at least one exemplary embodiment, the health managing device 1 further comprises a display screen 11, a voice input device 12, a camera 13, a collecting device 14, a positioning device 15, a storage 16, and a processor 17. The doctor terminal 2 further comprises a display screen 21, a voice input device 22, and a camera 23.

Each of the display screens 11, 21 can be a multi-touch panel, such as a resistive touch screen or a capacitive touch screen. In at least one exemplary embodiment, each of the health managing device 1 and the doctor terminal 2 can comprise a keyboard for inputting information to the health managing device 1 and the doctor terminal 2.

In one exemplary embodiment, each of the voice input devices 12, 22 can be a microphone. In another exemplary embodiment, each of the voice input devices 12, 22 can be an earphone. Each of the cameras 13, 23 can be installed inside of the health managing device 1 and the doctor terminal 2, or connected outside of the health managing device 1 and the doctor terminal 2.

The positioning device 15 is configured to obtain the present position of the health managing device 1. The positioning device 15 can be global positioning system (GPS) device, an assisted global positioning system (AGPS), BeiDou navigation satellite system (BDS), or GLOBAL NAVIGATION SATELLITE SYSTEM (GLONASS).

In at least one exemplary embodiment, the cloud server 3 stores first data uploaded by the health managing device 1 and second data uploaded by the doctor terminal 2.

In one exemplary embodiment, the first data uploaded by the health managing device 1 can be the physiological data which is collected by the collecting device 14.

In at least one exemplary embodiment, the physiological data comprises the blood pressure, the electrocardio, the blood glucose, the body fat, or the blood oxygen of a user. When the health managing device 1 uploads the physiological data to the cloud server 3, the health managing device 1 uploads the time of collecting the physiological data to the cloud server 3, thus the cloud server 3 stores the physiological data and the time of collecting the physiological data from health managing device 1.

In at least one exemplary embodiment, the second data uploaded by the doctor terminal 2 can be historical diagnostic records of the user. The historical diagnostic records comprises the number of times a diagnosis of the user was made, the physiological data of the user in relation to the number of diagnoses, and conclusions as to disorders of the user from doctors.

In at least one exemplary embodiment, the cloud server 3 further stores the basic information of a plurality of hospitals, such as a position of each hospital, a name of each hospital, a plurality of departments of each hospital, a plurality of doctors of each department, and a schedule of each doctor. In at least one exemplary embodiment, the basic information of each hospital further comprises the detailed information, such as the age of each hospital, a type of each hospital (a public hospital or a private hospital), and the detailed information of each doctor (such as a job title of the doctor and the work experience of the doctor).

In at least one exemplary embodiment, the cloud server 3 further stores a plurality of usernames and a plurality of passwords. Each username corresponds to one doctor. Each username corresponds to one password. Each doctor can login into the cloud server 3 by inputting the corresponding username and the corresponding password. The cloud server 3 is configured to receive the input username and the input password after each doctor inputs the corresponding username and the corresponding password. The doctor is deemed online, when the input username and the stored username are the same and the input password and the stored password are the same. The doctor is deemed offline, when the input username is different from the stored username and the input password is different from the stored password.

In at least one exemplary embodiment, the cloud server 3 also stores medical treatment and nursing information. The medical treatment and nursing information comprises a plurality of articles about the disease and body health care, such as a plurality of articles about high blood pressure, hypoglycemia, and heart disease. The medical treatment and nursing information can be classified stored in the cloud server 3, according to the corresponding disease, for example, the medical treatment and nursing information about the high blood pressure is set to be a first label and stored in the cloud server 3, the medical treatment and nursing information about the hypoglycemia is set to be a second label and stored in the cloud server 3.

In at least one exemplary embodiment, the storage 16 stores data from the health managing device 1, such as the procedure code of the health managing system 10. In at least one exemplary embodiment, the storage 16 can be an internal storage installed inside of the health managing device 15, or be a detachable storage card, such as a secure digital (SD) card.

In at least one exemplary embodiment, the health managing system 10 can be divided into modules, at least one module is stored in the storage 16 and is executed by at least one processor (such as the processor 17).

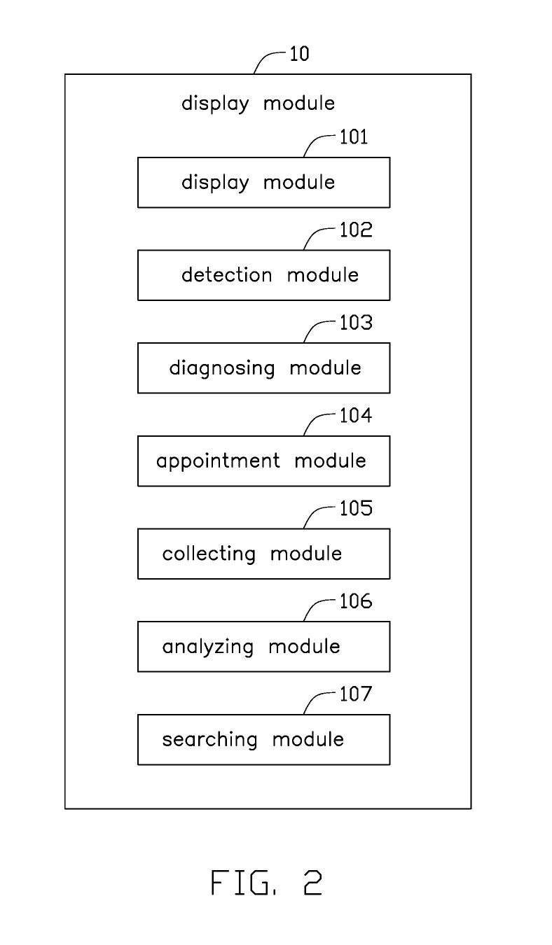

FIG. 2 illustrates that in at least one exemplary embodiment, the health managing system 10 is divided into a display module 101, a detection module 102, a diagnosing module 103, an appointment module 104, a collecting module 105, an analyzing module 106, and a searching module 107.

The display module 101 provides an operating interface 110. The operating interface 110 is displayed on the display screen 11 of the health managing device 1. The user can execute a plurality of operations on the operating interface 110.

In at least one exemplary embodiment, the operating interface 110 comprises a plurality of function options. Each function option corresponds to one function. The detection module 102 is configured to trigger the function corresponding to the selected function option.

In at least one exemplary embodiment, each function option can be relevant to a button. When a user clicks the button, the detection module 102 triggers the corresponding function in relation to the function option of the clicked button.

In at least one exemplary embodiment, the plurality of function options comprise a function option of diagnosing online, a function option of appointment register, a function option of collecting physiological data, and a function option of searching data.

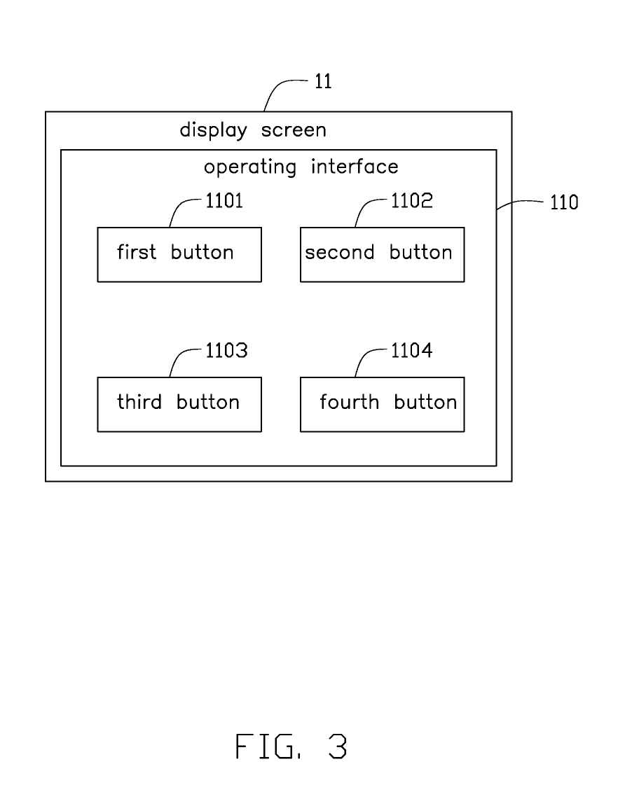

FIG. 3 illustrates that an operating interface 110 is displayed on the display screen 11. The operating interface 110 comprises a first button 1101, a second button 1102, a third button 1103, and a fourth button 1104.

In the exemplary embodiment, the first button 1101 is relevant to the function option of diagnosing online, the second button 1102 is relevant to the function option of appointment register, the third button 1103 is relevant to the function option of collecting physiological data, and the fourth button 1104 is relevant to the function option of searching data.

The detection module 102 is configured to determine which function option is selected by a user. In at least one exemplary embodiment, the detection module 102 is configured to detect whether the button of the operating interface 110 receives an input signal.

In the exemplary embodiment, the input signal can be a touching signal generated from the user when the user touches the button. In another exemplary embodiment, the input signal also can be a clicking signal when the user clicks the button through a mouse.

The detection module 102 is configured to determine which function option is selected by the user according to the input signal. For example, when the first button 1101 receives the input signal, the detection module 102 determines that the function option of diagnosing online is selected by the user; when the second button 1102 receives the input signal, the detection module 102 determines that the function option of appointment register is selected by the user; when the third button 1103 receives the input signal, the detection module 102 determines that the function option of collecting physiological data is selected by the user; and when the fourth button 1104 receives the input signal, the detection module 102 determines that the function option of searching data is selected by the user.

The detection module 102 is further configured to determine which doctor is selected by the user when the function option of appointment register or the function option of diagnosing online is selected by the user.

In at least one exemplary embodiment, the display module 101 is further configured to obtain the basic information of the plurality of hospitals from the cloud server 3 and display the obtained basic information of each hospital on the display screen 11.

The health managing device 1 communicates with the cloud server 3 through the network 4, thereby enabling the display module 101 to obtain the various information of the plurality of hospitals from the cloud server 3. The network 4 can be the wired network or the wireless network, such as the Internet, the local area network, the WI-FI, the honeycomb, the satellite, and the broadcast. The wireless communication can be the GSM, the GPRS, the CDMA, the W-CDMA, the CDMA2000, the IMT Single Carrier, the EDGE, the LTE, the TD-LTE, the HiperLAN, the HiperWAN, the LMDS, the WiMAX, the ZIGBEE, the BLUETOOTH, the Flash-OFDM, the HC-SDMA, the UMTS, the UMTS-TDD, the HSPA+, the TD-SCDMA, the EV-DO, and the DECT.

In at least one exemplary embodiment, the display module 101 obtains a present position of the health managing device 1 through the positioning device 15. The display module 101 sets a predetermined distance (such as 5 kilometers). The display module 101 displays an ordered list of the hospitals on the display screen 11 when a distance between the hospitals and the health managing device 1 is less than the predetermined distance, according to the present position of the health managing device 1, thus the user can select a near hospital and select the doctor.

In at least one exemplary embodiment, the positioning device 15 can be the GPS device, the AGPS, the BDS, or the GLONASS.

The health managing device 1 communicates with the doctor terminal 2 of the selected doctor, through the diagnosing module 103, to realize the remote diagnosis online.

In at least one exemplary embodiment, a diagnosing mode of the diagnosing online can be a video dialogue mode, a verbal communication mode, or a sound communication mode, or a combination of the above several modes. For example, the diagnosing module 103 switches on the voice input device 12 and the camera 13 to enable the health managing device 1 to communicate with the doctor terminal 2 of the selected doctor, to realize the remote diagnosis online by a video dialogue mode.

In at least one exemplary embodiment, the display module 101 displays one corresponding sign on the display screen 11 according to a state of the doctor. The state of the doctor can be an online state or an offline state. For example, when a doctor A is online, the display module 101 signs an “online” sign closes to the head portrait of the doctor A, and when the doctor A is offline, the display module 101 signs an “offline” sign closes to the head portrait of the doctor A.

In at least one exemplary embodiment, the detection module 102 is further configured to determine whether the currently selected doctor is online. In a first exemplary embodiment, when the currently selected doctor is offline, the appointment module 104 responds to the user and makes an appointment with the doctor within the specified time. In a second exemplary embodiment, when the currently selected doctor is online, the diagnosing module 103 is triggered to be executed.

In at least one exemplary embodiment, the appointment module 104 is further configured to prompt the user in a specified way when finishing making the appointment with the doctor.

In at least one exemplary embodiment, the specified way can be a first way of sending a text message to a specified cell phone number of the user, a second way of sending an E-mail to a specified email address of the user, or a third way of recording the specified time in a calendar and prompting the user at a prompting time. In one exemplary embodiment, the prompting time can be the day before the specified time. In another exemplary embodiment, the prompting time can be a half of the day before the specified time.

The collecting module 105 collects the physiological data of the user when the user selects the function option of collecting physiological data.

In at least one exemplary embodiment, the collecting module 105 collects the physiological data of the user through the collecting device 14.

In at least one exemplary embodiment, the collecting module 105 stores the collected physiological data and the time of collecting the physiological data to the storage 16. When the time period of collecting the physiological data which is stored in the storage 16 is equal to a predetermined time (such as three months), the collecting module 105 uploads the collected physiological data and the time of collecting the physiological data to the cloud server 3. When the physiological data (which is stored in the storage 16) is uploaded to the cloud server 3, the collecting module 105 further deletes the uploaded physiological data from the storage 16.

In another exemplary embodiment, the collecting module 105 directly stores the collected physiological data and the time of collecting the physiological data to the cloud server 3.

The analyzing module 106 is configured to compare the collected physiological data with a predetermined range and analyze the physical condition of the user to generate an analysis report. In at least one exemplary embodiment, the analyzing module 106 can analyze the physical condition of the user after the collecting module 105 finishes collecting all physiological data of the user.

The analyzing module 106 is further configured to display the analysis report on the display screen 11. The analyzing module 106 is also configured to upload each analysis report to cloud server 3.

In a first exemplary embodiment, when the collected physiological data is outside the predetermined range, the analyzing module 106 signs the physiological data (which is outside the predetermined range) in the analysis report to prompt the user to pay attention to health through a specified color (such as yellow).

In a second exemplary embodiment, when the collected physiological data is outside the predetermined range, the analyzing module 106 determines a diagnosing department according to the collected physiological data. The analyzing module 106 recommends the diagnosing department of the specified hospitals to the user.

In at least one exemplary embodiment, the specified hospitals can be a nearest hospital (a distance between the health managing device 1 and the nearest hospital being the shortest being the shortest). In another exemplary embodiment, the specified hospitals also can be the most popular hospital (such as the top hospital of all the most popular hospitals).

For example, when the collected physiological data is a blood pressure value of a user and the blood pressure value of the user without a normal blood pressure scope, the analyzing module 106 determines that the diagnosing department corresponding to the collected blood pressure is the cardiovascular department. The analyzing module 106 determines that a nearest hospital is the hospital B, according to the present position of the health managing device 1, and recommends the cardiovascular department of the hospital B to the user.

In at least one exemplary embodiment, the analyzing module 106 further recommends the medical care information in relation to the collected physiological data to the user. For example, when the blood pressure value of the user is on the high side, the analyzing module 106 recommends the medical care information in relation to the high blood pressure to the user, from the cloud server 3.

The appointment module 104 also prompts the user whether makes a diagnosing appointment. The appointment module 104 further executes the operation of making a diagnosing appointment with a doctor when the user needs to make a diagnosing appointment.

When the user selects the function option of searching data, the searching module 107 responds to the selection of the user to obtain the physiological data, and displays the obtained physiological data to the user.

In at least one exemplary embodiment, the searching module 107 searches the physiological data when the user inputs a specified period of time and displays the found physiological data on the display screen 11, according to the specified period of time specified by the user.

In at least one exemplary embodiment, when the physiological data, in relation to the specified period of time, is stored in the storage 16, the searching module 107 searches the corresponding physiological data from the storage 6 and displays the found physiological data on the display screen 11.

In another exemplary embodiment, when the physiological data, in relation to the specified period of time, is stored in the cloud server 3, the searching module 107 searches the corresponding physiological data from the cloud server 3 and displays the found physiological data on the display screen 11.

Specifically, when the user selects the function option of searching data, the searching module 107 responds to the selection of the user to search the medical care information from the cloud server 3, and displays the found medical care information on the display screen 11.

In at least one exemplary embodiment, the analyzing module 106 is configured to analyze the obtained physiological data, generate analysis results, and generate prompts corresponding to the analysis results. For example, within the specified time period (such as for a week), the blood glucose level of the user is less than a regular range of blood glucose and the blood glucose levels of the user are gradually reducing; and the analyzing module 10 prompts the user to strengthen nutrition and suggests the user see a doctor.

In at least one exemplary embodiment, when the obtained physiological data is outside the predetermined range, the analyzing module 106 determines a diagnosing department according to the collected physiological data. The analyzing module 106 recommends the diagnosing departments of the specified hospitals to the user. As described earlier, the specified hospitals can be a nearest hospital (a distance between the health managing device 1 and the nearest hospital being the shortest).

In another exemplary embodiment, the specified hospitals also can be the most popular hospital (such as the top hospital of all the most popular hospitals).

The appointment module 104 is also configured to prompt the user to consider making a diagnosing appointment. The appointment module 104 further executes the operation of making a diagnosing appointment when the user needs to make a diagnosing appointment.

In at least one exemplary embodiment, the analyzing module 106 recommends the medical care information in relation to the collected physiological data to the user.

For example, when the blood pressure value of the user is on the high side, the analyzing module 106 recommends the medical care information in relation to the high blood pressure to the user, from the cloud server 3.

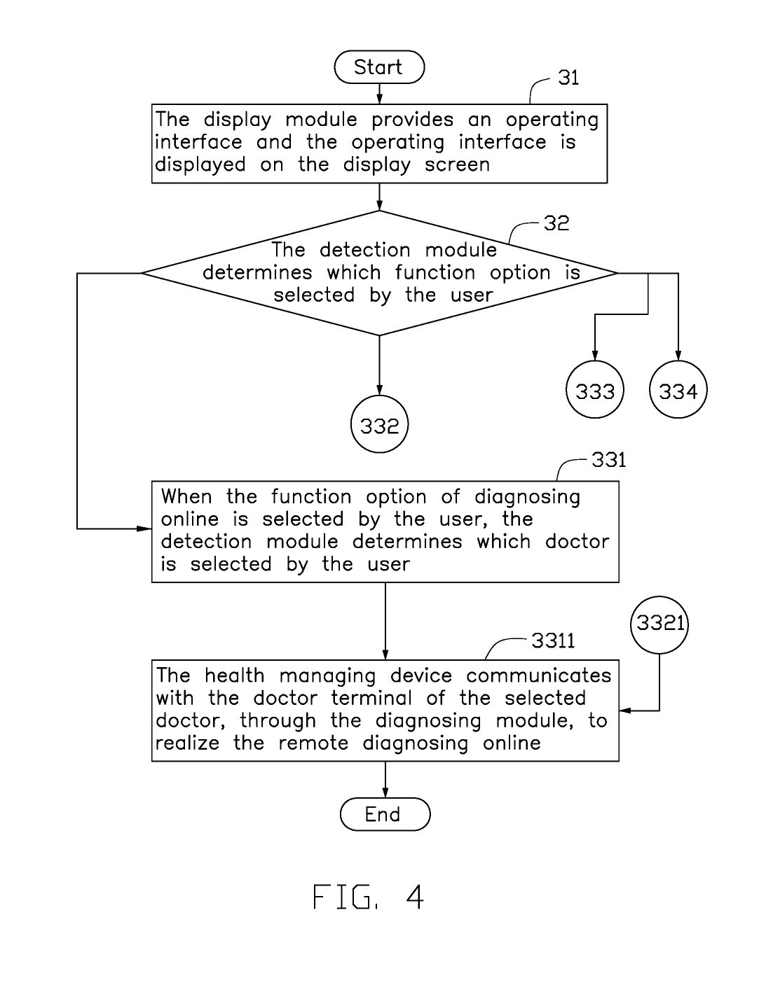

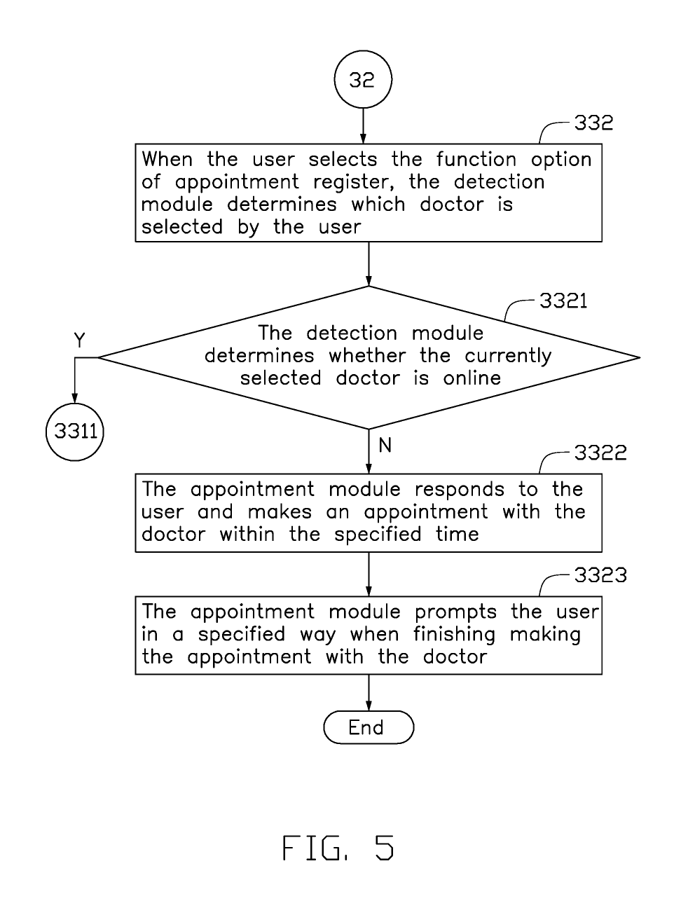

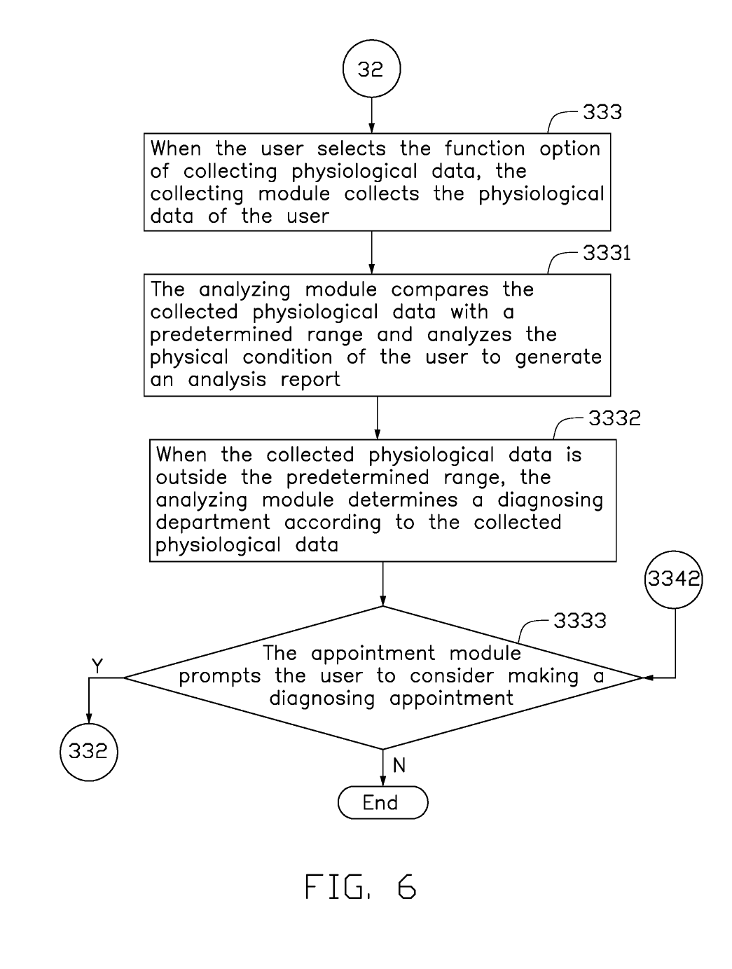

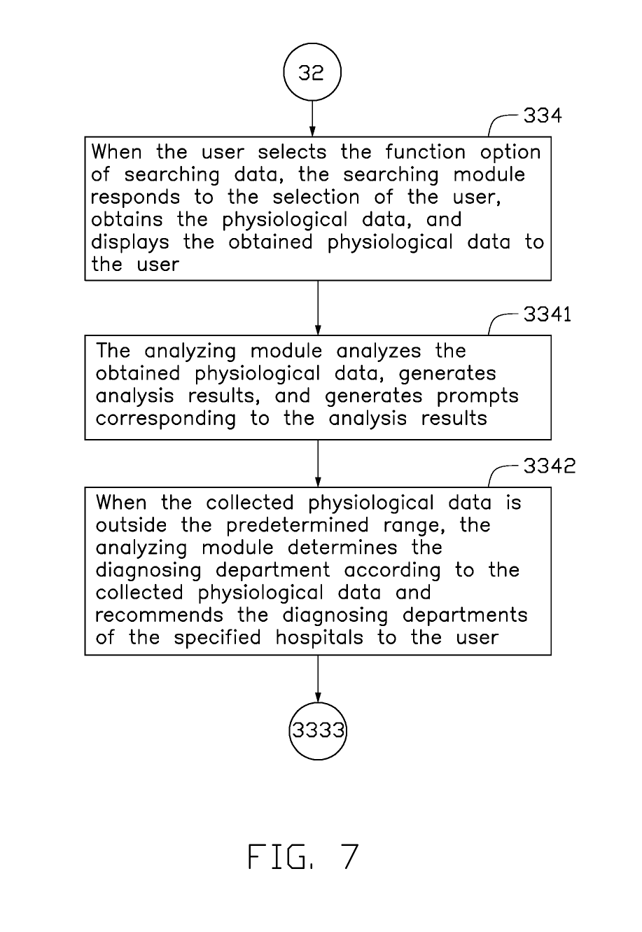

FIGS. 4-7 illustrate a flowchart of a method in accordance with an example embodiment. A health managing method is provided by way of example, as there are a variety of ways to carry out the method. The method described below can be carried out using the configurations illustrated in FIGS. 1-3, for example, and various elements of these figures are referenced in explaining the health managing method. The illustrated order of blocks is by example only and the order of the blocks can change. Additional blocks may be added or fewer blocks may be utilized without departing from this disclosure. The health managing method can begin at block 31.

At block 31, the display module 101 provides an operating interface 110 and the operating interface 110 is displayed on the display screen 11 of the health managing device 1.

In at least one exemplary embodiment, the operating interface 110 comprises a plurality of function options, the detection module 102 triggers the function in relation to the selected function option when the function option is selected by the user.

In at least one exemplary embodiment, each function option can be relevant to a button. When a user clicks the button, the detection module 102 triggers the corresponding function (the corresponding function is in relation to the function option of the clicked button).

In at least one exemplary embodiment, the plurality of function options comprise a function option of diagnosing online, a function option of appointment register, a function option of collecting physiological data, and a function option of searching data.

FIG. 3 illustrates that an operating interface 110 is displayed on the display screen 11. The operating interface 110 comprises a first button 1101, a second button 1102, a third button 1103, and a fourth button 1104. The first button 1101 is relevant to the function option of diagnosing online, the second button 1102 is relevant to the function option of appointment register, the third button 1103 is relevant to the function option of collecting physiological data, and the fourth button 1104 is relevant to the function option of searching data.

At block 32, the detection module 102 determines which function option is selected by the user. In detail, the detection module 102 detects the selected function option and determines which function option is selected by the user.

In at least one exemplary embodiment, the detection module 102 detects whether one button of the operating interface 110 is received an input signal from the user. In detail, the input signal can be a triggering signal triggered by the user when the user select one function option to press one button. The input signal also can be a clicking signal when the user clicks the button through the mouse.

In at least one exemplary embodiment, the detection module 102 determines which function option is selected by the user according to the button (which receives the input signal).

For example, when the first button 1101 receives the input signal, the detection module 102 determines that the function option of diagnosing online is selected by the user. Then, the method goes to block 331. When the second button 1102 receives the input signal, the detection module 102 determines that the function option of appointment register is selected by the user; then, the method goes to block 332. When the third button 1103 receives the input signal, the detection module 102 determines that the function option of collecting physiological data is selected by the user. Then, the method goes to block 333. When the fourth button 1104 receives the input signal, the detection module 102 determines that the function option of searching data is selected by the user. Then, the method goes to block 334.

At block 331, when the function option of diagnosing online is selected by the user, the detection module 102 determines which doctor is selected by the user. Then, the method goes to block 3311.

In at least one exemplary embodiment, the display module 101 can obtain basic information of a plurality of hospitals from the cloud server 3 and displays the obtained basic information on the display screen 11.

In at least one exemplary embodiment, the obtained basic information comprises a position of each hospital, the name of each hospital, a plurality of departments t of each hospital, each position of each department doctor, and a schedule of each doctor. Thus, the user can select the doctors according to the basic information of the plurality of hospitals.

In at least one exemplary embodiment, the basic information of each hospital further comprises the detailed information, such as the age of each hospital, a type of each hospital (a public hospital or a private hospital), and the detailed information of each doctor (such as a job title of the doctor and the work experience of the doctor).

In at least one exemplary embodiment, the cloud server 3 communicates with the health managing device 1 through the network 4, thus the display module 101 can obtain the information of the plurality of hospitals from cloud server 3. The network 4 can be wired network or wireless network, such as the Internet, the local area network, the WI-FI, the honeycomb, the satellite, and the broadcast. The wireless communication can be the GSM, the GPRS, the CDMA, the W-CDMA, the CDMA2000, the IMT Single

Carrier, the EDGE, the LTE, the TD-LTE, the HiperLAN, the HiperWAN, the LMDS, the WiMAX, the ZIGBEE, the BLUETOOTH, the Flash-OFDM, the HC-SDMA, the UMTS, the UMTS-TDD, the HSPA+, the TD-SCDMA, the EV-DO, and the DECT.

In at least one exemplary embodiment, the display module 101 is configured to obtain a present position of the health managing device 1 through the positioning device 15. The display module 101 is also configured to set a predetermined distance (such as 5 kilometers). The display module 101 displays an ordered list of the hospitals on the display screen 11 when a distance between the hospitals and the health managing device 1 is less than the predetermined distance, according to the present position of the health managing device 1, thereby enabling the user to select the closer hospital and select the corresponding doctor.

In at least one exemplary embodiment, the positioning device 15 can be GPS device, AGPS, BDS, or GLONASS.

At block 3311, the health managing device 1 communicates with the doctor terminal 2 of the selected doctor, through the diagnosing module 103, to realize the remote diagnosis online. Then, the method goes to end.

In at least one exemplary embodiment, a diagnosing mode of the diagnosing online can be a video dialogue mode, a verbal communication mode, or a sound communication mode.

In another exemplary embodiment, a diagnosing mode of the diagnosing online can be a combination of the above several modes.

For example, the diagnosing module 103 switches on the voice input device12 and the camera 13 to enable the health managing device 1 to communicate with the doctor terminal 2 of the selected doctor, to realize the remote diagnosis online by a video dialogue mode.

At block 332, when the user selects the function option of appointment register, the detection module 102 determines which doctor is selected by the user.

In at least one exemplary embodiment, the display module 101 displays one corresponding sign on the display screen 11 according to a state of the doctor (a state of the doctor can be online or offline). For example, when a doctor A is online, the display module 101 signs an “online” sign near to the head portrait of the doctor, and when the doctor A is outline, the display module 101 signs an “outline” sign near to the head portrait of the doctor. Thus, the user can know whether a doctor is online according the corresponding sign.

At block 3321, the detection module 102 determines whether the currently selected doctor is online.

In at least one exemplary embodiment, when the currently selected doctor is online, the method goes to block 3311; when the currently selected doctor is offline, the method goes to block 3322.

In another exemplary embodiment, no matter the currently selected doctor is online or offline, the method goes to block 3322. Thus block 3321 can be canceled and block 3322 is executed after block 332.

At block 3322, the appointment module 104 responds to the user and makes an appointment with the doctor within the specified time. Block 3323 is executed after block 3322.

At block 3323, the appointment module 104 prompts the user in a specified way when finishing making the appointment with the doctor. Then, the method goes to end.

In at least one exemplary embodiment, the specified way can be a first way of sending a text message to a specified cell phone number of the user, a second way of sending an E-mail to a specified email address of the user, or a third way of recording the specified time in a calendar and prompting the user at a prompting time. The prompting time can be the day before the specified time or be the time before the half-specified time.

At block 333, when the user selects the function option of collecting physiological data, the collecting module 105 collects the physiological data of the user. The collecting module 105 collects the physiological data of the user through the collecting device 14. The collecting module 105 also stores the time of collecting the physiological data. Then, the method goes to block 3331.

In at least one exemplary embodiment, the collecting module 105 stores the collected physiological data and the time of collecting the physiological data to the storage 16. When the time period of collecting the physiological data stored in the storage 16 is equal to a predetermined time (such as three months), the collecting module 105 uploads the collected physiological data and the time of collecting the physiological data (which are stored in the storage 16) to the cloud server 3. When the physiological data (which is stored in the storage 16) is uploaded to the cloud server 3, the collecting module 105 further deletes the uploaded physiological data from the storage 16.

In another exemplary embodiment, the collecting module 105 directly stores the collected physiological data and the time of collecting the physiological data to the cloud server 3.

In at least one exemplary embodiment, the physiological data comprises the blood pressure, the electrocardio, the blood glucose, the body fat, or the blood oxygen.

At block 3331, the analyzing module 106 compares the collected physiological data with a predetermined range and analyzes the physical condition of the user to generate an analysis report.

In the exemplary embodiment, the analyzing module 106 can analyze the physical condition of the user after the collecting module 105 finishes collecting all physiological data of the user.

The analyzing module 106 displays the analysis report on the display screen 11. The analyzing module 106 also uploads each analysis report to cloud server 3.

In at least one exemplary embodiment, when the collected physiological data is outside the predetermined range, the analyzing module 106 signs physiological data in the analysis report to prompt the user to pay attention to health through a specified color (such as yellow).

At block 3332, when the collected physiological data is outside the predetermined range, the analyzing module 106 determines that a diagnosing department according to the collected physiological data. The analyzing module 106 recommends the diagnosing departments of the specified hospitals to the user. Then, the method goes to block 3333.

In at least one exemplary embodiment, the specified hospitals can be a nearest hospital (a distance between the health managing device 1 and the nearest hospital being the shortest).

In another exemplary embodiment, the specified hospitals also can be the most popular hospital (such as the top hospital of all the most popular hospitals).

For example, when the collected physiological data is a blood pressure value of a user and the blood pressure value of the user without a normal blood pressure range, the analyzing module 106 determines the diagnosing department corresponding to the collected physiological data is the cardiovascular department. The analyzing module 106 determines that a nearest hospital is hospital B, according to the present position of the health managing device 1, recommends the cardiovascular department of hospital B to the user.

In at least one exemplary embodiment, the analyzing module 106 further recommends the medical care information in relation to the collected physiological data to the user.

For example, when the blood pressure value of the user is on the high side, the analyzing module 106 recommends the medical care information in relation to the high blood pressure to the user, from the cloud server 3.

At block 3333, the appointment module 104 prompts the user to consider making a diagnosing appointment. When the user needs to make a diagnosing appointment with a doctor, the method goes to block 332, to execute the operation of making a diagnosing appointment. When the user does not need to make a diagnosing appointment with a doctor, the method goes to end.

At block 334, when the user selects the function option of searching data, the searching module 107 responds to the selection of the user, obtains the physiological data, and displays the obtained physiological data to the user.

In at least one exemplary embodiment, the searching module 107 obtains the physiological data in a specified period of time and displays the searching physiological data on the display screen 11, according to the specified period of time by the user.

In at least one exemplary embodiment, when the physiological data in the specified period of time is stored in the storage 16, the searching module 107 searches out the corresponding physiological data from the storage 6 and displays the found physiological data on the display screen 11; when the physiological data in the specified period of time is stored in the cloud server 3, the searching module 107 searches out the corresponding physiological data from the cloud server 3 and displays the found physiological data on the display screen 11.

Specifically, when the user selects the function option of searching data, the searching module 107 responds to the selection of the user to search out the medical care information from the cloud server 3, and displays the found medical care information on the display screen 11.

In at least one exemplary embodiment, the health managing method further comprises block 3341 and block 3342.

In another exemplary embodiment, the method goes to end after the block 334.

At block 3341, the analyzing module 106 analyzes the obtained physiological data, generates analysis results, and generates prompts corresponding to the analysis results.

For example, within the specified time period (such for a week), the blood glucose levels of the user is less than a blood glucose scope and the blood glucose levels of the user are gradually reduced, the analyzing module 10 prompts the user to strengthen nutrition and suggests the user to see a doctor.

At block 3342, when the collected physiological data is outside the predetermined range, the analyzing module 106 determines the diagnosing department according to the collected physiological data and recommends the diagnosing departments of the specified hospitals to the user. Then, the method goes to block 3333.

As described earlier, the specified hospitals can be a nearest hospital (a distance between the health managing device 1 and the nearest hospital being the shortest). In another exemplary embodiment, the specified hospitals also can be the most popular hospital (such as the top hospital of the most popular hospitals).

In at least one exemplary embodiment, the analyzing module 106 further recommends the medical care information in relation to the collected physiological data to the user.

For example, when the blood pressure value of the user is on the high side, the analyzing module 106 recommends the medical care information in relation to the high blood pressure to the user, from the cloud server 3.

The exemplary embodiments shown and described above are only examples. Many details are often found in the art such as the other features of a health managing device and a health managing method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A health managing device comprising:
a storage;
at least one processor;
a display screen;
a display module; and
a detection module;
wherein each of the display module and the detection module is stored in the storage;
wherein the display module is configured to provide an operating interface;
wherein the operating interface is displayed on the display screen;
wherein the operating interface comprises a plurality of function options;
wherein the detection module is configured to determine which function option is selected by a user;
wherein the detection module is further configured to trigger the function corresponding to the selected function option.

2. The health managing device of claim 1, further comprising a diagnosing module, wherein the diagnosing module is stored in the storage, the plurality of function options comprises a function option of diagnosing online, the detection module is further configured to determine which doctor is selected by the user when the function option of diagnosing online is selected by the user; when the selected doctor is online, the health managing device communicates with a doctor terminal of the selected doctor, through the diagnosing module, to realize the remote diagnosis online.

3. The health managing device of claim 2, further comprising an appointment module, wherein the appointment module is stored in the storage, the plurality of function options further comprises a function option of appointment register, the detection module is further configured to determine which doctor is selected by a user when the function option of appointment register is selected by the user; when the selected doctor is offline, the appointment module is configured to respond to an operation of the user and make an appointment with the selected doctor within a specified time.

4. The health managing device of claim 3, wherein the appointment module is configured to prompt the user in a specified way when finishing making the appointment with the doctor, the specified way can be a first way of sending a text message to a specified cell phone number of the user, a second way of sending an E-mail to a specified email address of the user, or a third way of recording the specified time in a calendar and prompting the user at a prompting time.

5. The health managing device of claim 3, further comprising a positioning device, wherein the display module is further configured to:
obtain a present position of the health managing device through the positioning device; and
display an ordered list of hospitals on the display screen when a distance between the hospitals and the health managing device is less than a predetermined distance, according to the present position of the health managing device.

6. The health managing device of claim 3, wherein the plurality of function options comprises a function option of collecting physiological data, the health managing device further comprises:
a collecting module stored in the storage; and
an analyzing module stored in the storage;
wherein the collecting module is configured to:
collect the physiological data of the user when the user selects the function option of collecting physiological data;
store the collected physiological data; and
store the time of collecting the physiological data;
wherein the collecting module is configured to:
compare the collected physiological data with a predetermined range;
analyze the physical condition of the user;
generate an analysis report; and
display the generated analysis report on the display screen.

7. The health managing device of claim 6, wherein the health managing device communicates with a cloud server, the collecting module is further configured to:
store the collected physiological data to the storage;
store the time of collecting the physiological data to the storage; and
upload the collected physiological data and the time of collecting the physiological data which are stored in the storage to the cloud server, when the time of collecting the physiological data stored in the storage is equal to a predetermined time.

8. The health managing device of claim 6, further comprising a searching module stored in the storage, wherein the plurality of function options comprises a function option of searching data, the searching module is configured to:
respond to the selection of the user;
obtain the physiological data; and
display the obtained physiological data to the user;
wherein the analyzing module is further configured to:
analyze the obtained physiological data;
generate analysis results;
generate prompts corresponding to the analysis results;
determine the diagnosing department according to the collected physiological data when the collected physiological data is outside the predetermined range; and
recommend the diagnosing departments of a plurality specified hospitals to the user;
wherein the appointment module is further configured to:
prompt the user whether makes a diagnosing appointment; and
execute an operation of making a diagnosing appointment with a doctor when the user needs to make a diagnosing appointment.

9. The health managing device of claim 8, wherein the specified hospitals can be a nearest hospital or be a top hospital of the most popular hospitals, and a distance between the health managing device and the nearest hospital being the shortest.

10. A health managing device comprising:
a storage;
at least one processor;
a display screen; and
at least one module;
wherein the at least one module is stored in the storage;
wherein the at least one module is executed by at least one processor;
wherein the at least one module is configured to provide an operating interface;
wherein the operating interface is displayed on the display screen;
wherein the operating interface comprises a plurality of function options;
wherein the plurality of function options are configured to be selected by the user;
wherein each function option corresponds to one function;
wherein the detection module is configured to:
determine which function option is selected by a user; and
trigger the function corresponding to the selected function option.

11. A health managing method used in a health managing device, the health managing device comprises a storage and a display screen, and the health managing method comprising:
providing an operating interface and displaying the operating interface on the display screen of a health managing device, and the operating interface comprising a plurality of function options;
determining which function option is selected by a user; and
triggering a function corresponding to the selected function option.

12. The health managing method of claim 11, further comprising:
determining which doctor is selected by the user when a function option of diagnosing online is selected by the user; and
the health managing device communicating with a doctor terminal of the selected doctor to realize the remote diagnosis online when the selected doctor is online.

13. The health managing method of claim 12, further comprising:
determining which doctor is selected by the user when a function option of appointment register is selected by the user;
responding to an operation of the user; and
making an appointment with the selected doctor within a specified time.

14. The health managing method of claim 13, further comprising a step of prompting the user in a specified way after the step of making the appointment with the selected doctor, wherein the specified way can be a first way of sending a text message to a specified cell phone number of the user, a second way of sending an E-mail to a specified email address of the user, or a third way of recording the specified time in a calendar and prompting the user at a prompting time.

15. The health managing method of claim 13, further comprising:
obtaining a present position of the health managing device; and
displaying an ordered list of hospitals on the display screen when a distance between the hospitals and the health managing device is less than a predetermined distance, according to the present position of the health managing device.

16. The health managing method of claim 13, further comprising:
collecting the physiological data of the user when the user selecting the function option of collecting physiological data;
storing the collected physiological data;
storing the time of collecting the physiological data;
comparing the collected physiological data with a predetermined range;
analyzing the physical condition of the user;
generating an analysis report; and
displaying the generated analysis report on the display screen.

17. The health managing method of claim 16, further comprising:
storing the collected physiological data to the storage of the health managing device;
storing the time of collecting the physiological data to the storage; and
uploading the collected physiological data and the time of collecting the physiological data which are stored in the storage to a cloud server, when the time of collecting the physiological data stored in the storage is equal to a predetermined time;
wherein the health managing device communicating with the cloud server.

18. The health managing method of claim 16, further comprising:
responding to the selection of the user;
obtaining the physiological data;
displaying the obtained physiological data to the user;
analyzing the obtained physiological data;
generating analysis results;
generating prompts corresponding to the analysis results;
determining the diagnosing department according to the collected physiological data when the collected physiological data is outside the predetermined range;
recommending the diagnosing departments of a plurality specified hospitals to the user;
prompting the user whether makes a diagnosing appointment; and
executing an operation of making a diagnosing appointment with a doctor when the user needs to make a diagnosing appointment.

19. The health managing method of claim 18, wherein the specified hospitals can be a nearest hospital or be a top hospital of the most popular hospitals, and a distance between the health managing device and the nearest hospital being the shortest.

20. The health managing method of claim 18, further comprising a step of recommending medical care information in relation to the obtained physiological data to the user.
